(19) United States
(12) Patent Application Publication
(10) Pub. No.: US 2025/0215775 A1
(43) Pub. Date: Jul. 3, 2025

(54) RESISTIVITY INVERSION INTERPRETATION BY AI ASSISTANT DURING GEOSTEERING JOB

(71) Applicant: Halliburton Energy Services, Inc., Houston, TX (US)

(72) Inventors: Edgar Gutierrez Gonzalez, Houston, TX (US); Jeremy James Combs, Houston, TX (US); David Franklin Anthony, Houston, TX (US)

(21) Appl. No.: 18/402,190

(22) Filed: Jan. 2, 2024

(51) Int. Cl. E21B 44/00; E21B 49/00; G01V 3/20

(52) U.S. Cl. CPC E21B 44/00; E21B 7/04; E21B 47/0025; E21B 49/00; G01V 3/38; E21B 2200/22

(57) ABSTRACT

Some implementations include a system configured for real-time well path optimization of a wellbore being drilled into a subsurface formation, the system comprising: a downhole tool including a resistivity sensor; a drilling assembly coupled to a drill bit, the drilling assembly including the downhole tool; and a learning machine configured to, compare an input image of a resistivity inversion against an archive of historical data; generate, based on the comparison, a real-time well path suggestion; and output the real-time well path suggestion to a user interface.

### FIELD

Some implementations relate generally to navigating a drill string through the subsurface, more particularly, to the field of geosteering according to well path suggestions output from a learning machine.

### BACKGROUND

In operations for hydrocarbon and subsurface resource recovery, operators may need to geosteer a drill bit though one or more subsurface formations. Geosteering is a drilling technique used in the oil and gas industry to navigate a wellbore through a subsurface reservoir or target zone with a high degree of precision. The primary goal of geosteering is to optimize the placement of the wellbore within the reservoir, ensuring that it intersects the most productive and valuable hydrocarbon-bearing formations while avoiding non-productive or undesirable layers.

Geosteering relies on real-time data acquired during the drilling process. This data includes measurements of various parameters such as formation resistivity, gamma ray radiation, drilling rate, and mud properties. The real-time data may be used to make geological interpretations of the subsurface, and key markers or geological formations may be identified that can help determine the well's position relative to the target reservoir. Based on the geological interpretation, decisions are made to adjust the trajectory of the wellbore. This can involve steering the drilling assembly to move laterally within the reservoir or to change the well's depth to stay within the productive zone.

Geosteering may be easier if operators have an understanding of the subsurface formations they are drilling through. Logging while drilling (LWD) and measurement while drilling (MWD) tools may be placed or otherwise coupled to a bottomhole assembly (BHA) comprising the drill bit used to drill through the formation(s). One such tool may include a resistivity sensor used to obtain resistivity data of surrounding fluids and rock. Resistivity data may be processed and inverted in real-time. Resistivity inversion is the process of inverting the measured resistivity data to obtain a quantitative estimate of the resistivity distribution in the subsurface. In other words, it aims to create a resistivity model of the Earth's subsurface based on the measurements made in the wellbore.

Once the resistivity inversion is performed, a geosteerer may interpret the results to gain insights into the composition and fluid content of the rock formations. For example, the geosteerer may identify the presence of hydrocarbons, water-bearing zones, and other geological features. Using resistivity inversion, the geosteerer may predict subsurface formations and steer the drill bit on an efficient path to an optimal location. Correct interpretation of resistivity inversions are the main drivers for a successful geosteering operation. Most of the time, geosteerers may consult with other fellow colleagues for their opinion when interpreting resistivity inversion results. They may also reference historical reports/data when making decisions. This takes time, and when geosteering, it may be critical to make decisions as soon as possible.

### BRIEF DESCRIPTION OF THE DRAWINGS

Implementation of the disclosure may be better understood by referencing the accompanying drawings.

FIG. 1 depicts an example well system used to geosteer a well, according to some implementations.

FIG. 2 is block diagram depicting a method for generating resistivity inversion interpretation suggestions, according to some implementations.

FIG. 3 is a flow diagram depicting a training procedure for an example learning machine, according to some implementations.

FIG. 4 is a block diagram depicting an example computer, according to some implementations.

FIG. 5 is a flowchart of an example method for optimizing a well path of a wellbore being drilled into a subsurface formation in real-time, according to some implementations.

### OVERVIEW

Some example implementations may train a learning machine (also referred to as an artificial intelligence (AI) engine, deep learning algorithm, etc.) using the results of the resistivity inversion and other data related to the well (such as gamma ray radiation, drilling rate, mud properties, etc.). After training, the learning machine may provide resistivity inversion interpretation suggestions to a user in real time for resistivity inversion results (images) generated during a geosteering operation. The learning machine may analyze the real-time drilling data to output automatic suggestions to navigate the drill string along an optimal drilling path to a desired location (such as a particular formation or reservoir). Enabling geosteerers to quickly interpret resistivity inversion results with high confidence may improve job performance, enhance client relations, and drive confidence and competence of geosteerers on the job.

The description that follows includes example systems, methods, techniques, and program flows that embody aspects of the disclosure. However, it is understood that this disclosure may be practiced without these specific details. For instance, this disclosure refers to a learning machine configured to output well path suggestions to a user interface viewable by a geosteerer. Aspects of this disclosure may also be applied to any other configuration of devices configured to perform cuttings analysis. For clarity, some well-known instruction instances, protocols, structures, and techniques have been omitted.

### Example Well System

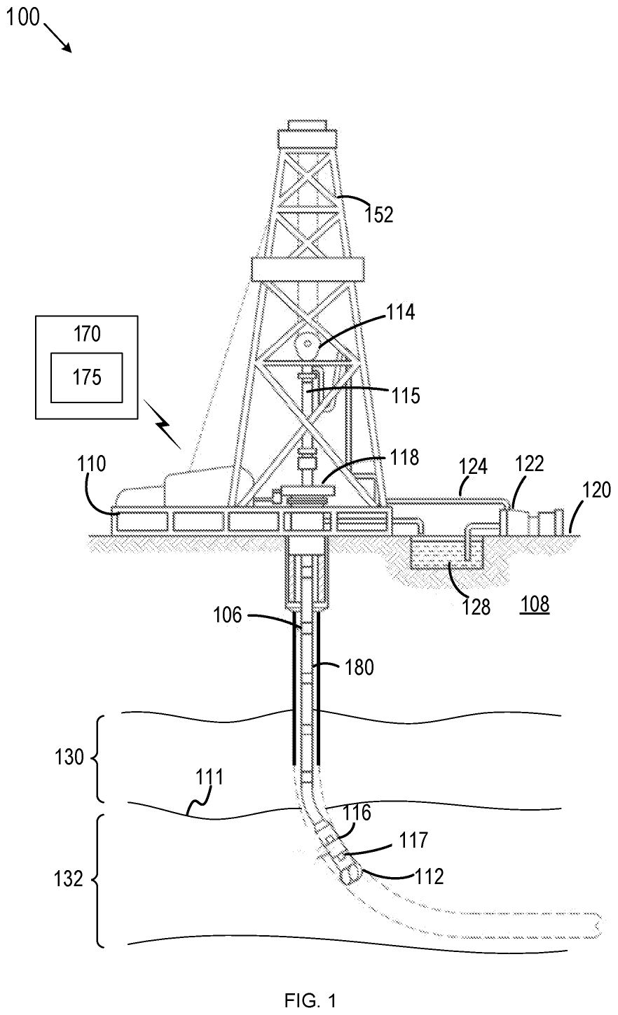

FIG. 1 depicts an example well system used to geosteer a well, according to some implementations. The well system 100 includes a drill string 180 having a drill bit 112 disposed in a wellbore 106 for drilling the wellbore 106 in the subsurface formation 108. While depicted for a land-based well system, example implementations may be used in subsea operations that employ floating or sea-based platforms and rigs.

The well system 100 may further include a drilling platform 110 that supports a derrick 152 having a traveling block 114 for raising and lowering the drill string 180. The drill string 180 may include, but is not limited to, drill pipe, drill collars, and drilling assembly 116. The drilling assembly 116 may comprise any of a number of different types of tools including a rotary steerable system (RSS), measurement while drilling (MWD) tools, logging while drilling (LWD) tools, mud motors, etc. A kelly 115 may support the drill string 180 as it may be lowered through a rotary table 118. The drill bit 112 may include roller cone bits, polycrystalline diamond compact (PDC) bits, electrocrushing bits, natural diamond bits, any hole openers, reamers, coring bits, etc. Drilling parameters of drilling the wellbore 106 may be adjusted to increase, decrease, and/or maintain the rate of penetration (ROP) of the drill bit 112 through the subsurface formation 108 and, additionally, steer the drill bit 112 through the subsurface formation 108. The subsurface formation 108 may include multiple formations such as formations 130, 132. The interface between the formations 130, 132 may be the formation bed boundary 111. The drilling parameters may assist in steering the wellbore 106 to avoid contact and/or penetration of the formation bed boundary 111. Drilling parameters may include weight-on-bit (WOB) and rotations-per-minute (RPM) of the drill string 180. A pump 122 may circulate drilling fluid through a feed pipe 124 to the kelly 116, downhole through interior of the drill string 180, through orifices in the drill bit 112, back to the surface 120 via an annulus surrounding the drill string 180, and into a retention pit 128.

In some implementations, various sections of the wellbore 106 such as the vertical, tangent, curve, and horizontal section may require directional drilling to steer the drill bit 112 on a planned well path and/or keep the wellbore 106 in a target formation. Sensors on the drilling assembly 116, such as gamma ray sensors, porosity sensors, resistivity sensors, etc., may log respective measurements while drilling the wellbore 106. The measurement logs may be obtained from the sensors on the drilling assembly 116 and uplinked to the surface 120. In some implementations, the measurements may be communicated to tools on the drilling assembly 116 for processing. The measurements may be processed and utilized to determine the location of the formation bed boundary 111.

In some implementations, a resistivity sensor 117 may collect resistivity data from surrounding rock and fluids within the formations 130, 132. The resistivity sensor 117 may be an MWD or LWD resistivity tool. The resistivity sensor 117 may be communicatively coupled to a computer 170 at the surface. The resistivity data collected by the resistivity sensor 117 may be communicated to the computer 170 in real-time. The computer 170 may include a user interface viewable by a geosteerer guiding the drill bit 112 through the formations 130, 132. The computer 170 may include one or more algorithms configured to invert the resistivity data received from the resistivity sensor 117 to create an image, also known as an interpretation, of a region around the drilling assembly 116. In some implementations, this interpretation of inverted resistivity data may enable visualization of the resistivity data of nearby formations and those being drilled in real-time via a heat map, a color smear, etc.

The computer 170 may include a geosteering system including a UI configured to display the resistivity inversion interpretation of the region around the drilling assembly 116 to the geosteerer. The computer 170 may also be configured to update the interpretation in real-time based on data received by the resistivity sensor 117. The computer 170 may also make predictions on the location of the formation bed boundary 111 based on received data.

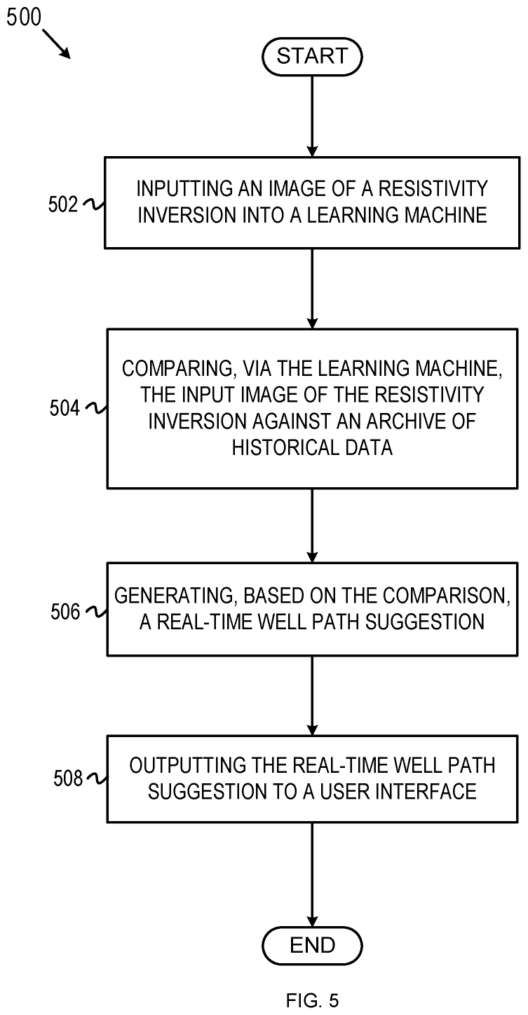

The computer 170 that may be communicatively coupled to other parts of the well system 100. The computer 170 may be local or remote to the drilling platform 110. A processor of the computer 170 may perform simulations (as further described below). In some implementations, the processor of the computer 170 may control drilling operations of the well system 100 or subsequent drilling operations of other wellbores. For instance, the processor of the computer 170 may determine the formation bed boundary 111 and determine steering inputs to avoid contacting the formation bed boundary 111. An example of the computer 170 is depicted in FIG. 5, which is further described below.

The computer 170 may be configured to interpret resistivity data from the resistivity sensor 117. For example, the computer 170 may include a learning machine 175 configured to interpret fluid contacts, formation boundaries, etc. of resistivity inversions. The learning machine 175 may include any suitable components for performing the machine-learning operations described herein (such as any suitable type of neural network). Resistivity inversion interpretations may be output from the learning machine 175 and accessed by the computer 170. In some implementations, the learning machine may output well path suggestions to a user interface based on the input resistivity inversion interpretation(s). In other implementations, suggestions output by the learning machine 175 may be presented on any suitable output device or otherwise electronically transmitted to other computing devices for further analysis and/or presentation. Geosteering decisions by the geosteerer may be determined based, at least in part, on the suggestions output by the learning machine 175. Resulting action may maintain the planned well path, remain in the target formation, and/or make adjustments to the drilling assembly 116 to maintain an optimal placement of the wellbore 106.

### Example Method for Outputting Well Path Suggestions

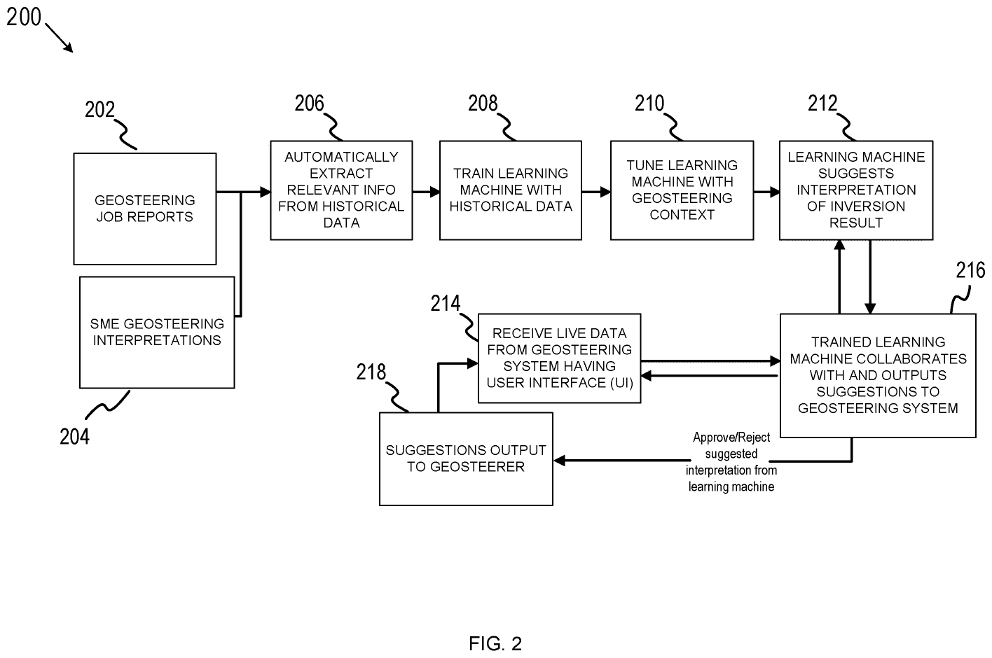

FIG. 2 is block diagram depicting a method 200 for generating resistivity inversion interpretation suggestions, according to some implementations. The computer 170 of FIG. 1 may be configured to and/or may comprise components configured to perform the method of FIG. 2. Flow of the method 200 begins at block 202.

At block 202, the method 200 includes accessing, via the computer 170, geosteering job reports from prior geosteering jobs. For example, the prior job reports may include images and associated image data of resistivity inversion interpretations and the actions past geosteerers initiated with regard to the interpretations. An archive of historical data and images from prior jobs may be accessed by the computer 170.

At block 204, the method 200 includes accessing geosteerer interpretations from subject matter experts (SMEs) into the computer 170. Outside of geosteering operations, SMEs may interpret resistivity inversion interpretations and include commentary as to what historical markers and/or points of interest within the interpretation image indicate, suggestions to alter a path of a wellbore based on the identified points of interest, etc. The geosteering job reports of block 202 and the SME interpretations of block 204 may both be used to train the learning machine 175 communicatively coupled to the computer 170. Flow of the method progresses from blocks 202 and 204 collectively to block 206.

At block 206, the method 200 includes automatically extracting relevant information from the imported information. For example, the computer 170 may be configured to extract relevant data from the geosteering job reports of block 202 and the SME Geosteerer Interpretations of block 204. Relevant data may refer to archived historical data similar to real-time resistivity inversion interpretations generated by the computer 170 based on data received from the resistivity sensor 117. The data may also include resistivity data pre-inversion. In some implementations, the computer 170 may include an image recognition model configured to identify trends in real-time resistivity inversion interpretations and correlate them to similar trends in historical interpretations. Flow progresses to block 208.

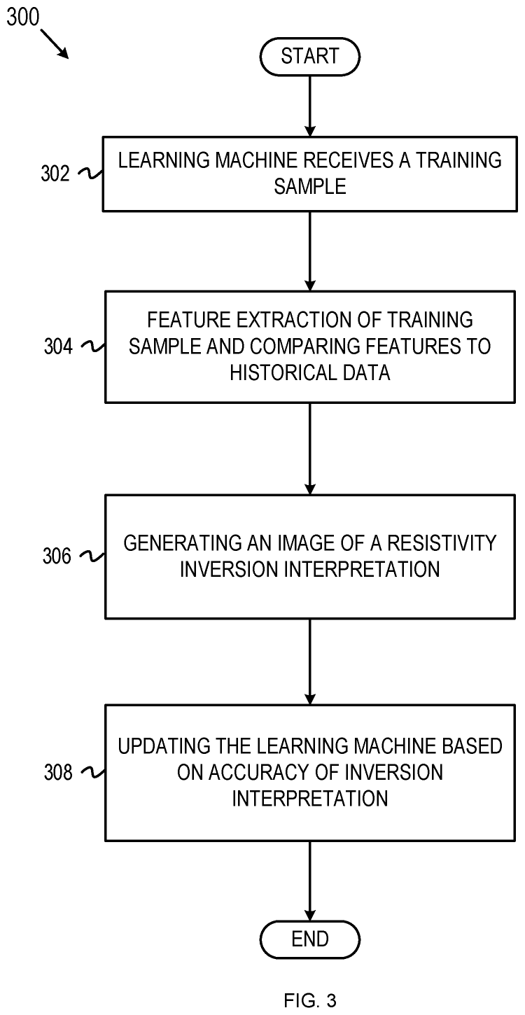

At block 208, the method 200 trains a machine learning (ML) algorithm with geosteering report information. For example, the learning machine 175 coupled with the computer 170 may be trained using the archived historical data of blocks 202, 204. FIG. 3 expands upon this training of the learning machine 175.

FIG. 3 is a flowchart depicting a training procedure for an example learning machine. The computer 170 of FIG. 1 may be configured to and/or may comprise components configured to perform the operations of FIG. 3. Flow of the flowchart 300 begins at block 302.

At block 302, the learning machine 175 receives a training sample. In some implementations, the training sample may include an image of a resistivity inversion and an archive of historical data. The historical data may be accessed by the learning machine 175 of FIG. 1 and described in block 208 of FIG. 2. For example, the historical data including geosteering job reports from prior geosteering jobs (similar to those in block 202), archived resistivity inversion interpretations from previous geosteering jobs, SME resistivity inversion interpretations (similar to those of block 204), an SME interpretation of the training sample's resistivity inversion image, subsurface data of nearby formations, general geosteering terminology/vernacular, etc. In some implementations, well log data from neighboring wells and/or data from prior-drilled wells may also be used with the historical geosteering data to train the learning machine. The historical data may include images (interpretations) of resistivity inversions as well as data and text associated with the interpretations and/or a-priori formation properties. Flow progresses to block 304.

At block 304, the learning machine 175 may extract features from the training sample (the resistivity inversion image) and compare the features to the historical data. For example, the learning machine 175 may parse the resistivity inversion image of the training sample into multiple sub-sections. In some implementations, the learning machine 175 may also dissect one or more inversion interpretations within the historical data into sub-sections for analysis. The learning machine 175 may identify information in the resistivity inversion image (training sample) and the historical data (e.g., the geosteering job reports) that is relevant to making an interpretation of the inversion image and providing a textual suggestion regarding a path of the wellbore 106. In some implementations, data from the geosteering job reports may of block 202 may make up one or more of the features within a feature set extracted by the learning machine 175.

In some implementations, the sub-sections within the training sample may be further divided into equal groups by a set interval of measured depth drilled, by time, etc. In other implementations, the sub-sections may be of uneven distribution, where the sub-sections are divided based on events of interest identified by the learning machine 175. The learning machine 175 may process the parsed images by comparing extracted features to the features within the historical data. For example, the learning machine 175 may process each sub-section by comparing patterns and trends within the sub-section to those in the historical data. This may include matching trends within a sub-section to similar trends in historical resistivity inversions and inversion interpretations. Example resistivity inversion interpretation images within the library of historical data may include text and/or related data (commentary, corrective actions, bed boundaries, and/or well path suggestions) that provide meaning, from the perspective of the learning machine 175, as to what the interpretation trends entail. This is how the learning machine 175 may establish the relationship between the resistivity inversion image in the training sample and the interpretations, descriptors, geosteering vernacular, corrective actions, etc. pertaining to trends in the input images within the historical data. To perform these operations, the learning machine 175 may include any individual or combination of image recognition and large language models/algorithms, although the learning machine 175 coupled to the computer 170 may include any suitable neural network (such as a convolutional neural network. Flow progresses to block 306.

At block 306, the learning machine 175 may generate a resistivity inversion interpretation including well path suggestions for the training sample. For example, the learning machine 175 may stitch together multiple sub-sections of resistivity inversions and/or resistivity data into a full image interpretation that may be of use by a geosteerer. The learning machine 175 may include functionality (such as software and/or hardware) to process the features of the resistivity inversion within the training sample and output the interpretation image. In some implementations, the interpretation may include bed boundaries, identified hazards, fluid contacts, and other subsurface features. The stitched interpretation may also include a suggested well path (e.g., denoted by a continuous line) for the geosteerer. In some implementations, the learning machine 175 may be configured to forecast the suggested well path based on identified formation trends/properties.

The stitched image may include one or more textual suggestions to guide the path of the wellbore within the stitched image. For example, the learning machine 175 may have identified that the drill bit is angled out of a pay zone and toward a high resistivity zone. Based on training through reference of the historical reports, the learning machine 175 may output a suggestion to angle away from the high resistivity zone and stay within the current formation. In some implementations, an SME may approve or deny the output suggestions to progress the training of the learning machine 175. Flow progresses to block 308.

At block 308, the learning machine 175 may be updated based on an accuracy of the resistivity inversion interpretation and textual suggestion. For example, the training sample's resistivity inversion image may correspond with an SME interpretation also accessible by the learning machine 175. The resistivity inversion interpretation output by the learning machine 175 may be compared to the corresponding SME interpretation. If the learning machine's interpretation is within an error threshold of the SME interpretation (used for validation), then flow of the flowchart 300 ceases. If the learning machine's interpretation is not within an error tolerance of an expected result, then the learning machine 175 may update to obtain better results. The updating may entail back propagation, updating weights, and other aspects of a neural network or other components of the learning machine 175. In some implementations, an SME may also approve or deny suggestions output from the learning machine 175 during training.

In some implementations, the training process depicted in FIG. 3 may be repeated for each training sample. The training process may include additional operations for training the learning machine 175. In some implementations, the learning machine may utilize 80% of the training samples for training and reserve the remaining 20% of the training samples to test itself and the validity of its well path suggestions. However, other training process configurations may be possible.

With reference to FIG. 2, the trained learning machine 175 may be further refined before deployment. At block 210, the learning machine 175 is tuned with geosteering context to reduce wrong outputs from occurring. In some implementations, the tuning may be manually performed by an SME or geosteerer, for example. Flow progresses to block 212.

At block 212, the trained learning machine 175 may complete its training by suggesting an interpretation of an inversion result. For example, the learning machine 175 of the computer 170 may output a resistivity inversion interpretation similar to the stitched image of block 306.

In some implementations, the learning machine 175 of the computer 170 may be configured to output resistivity inversion interpretation suggestions to a user interface viewable by a geosteerer. In some implementations, these may include textual commentary using geosteering vernacular. In some implementations, the interpretation suggestions may be viewable within a chat box, chat prompt, or other text space proximate to the image of the resistivity inversion interpretation. The suggestions may reference historical resistivity inversion reports as well as annotations from other geosteerers' reports. In some implementations, the learning machine 175 may be configured to output suggestions directly on the resistivity inversion interpretation image in the form of annotations. In some implementations, the annotations may be included on the output interpretation at points of interest. For example, annotations output by the learning machine 175 in real-time onto the inversion interpretation may include descriptors of zones and what they represent, wellbore hazards, fluid types, anomalies (e.g., casing effect), etc. In other implementations, the annotations may appear at the top of a UI of the geosteering system pertaining to the formation that the BHA is traveling through. The suggestions may be tailored to individual well goals, formations, producing reservoirs, geographic regions, districts, operators, etc. Both the resistivity inversion interpretation (image) suggestion and the textual suggestions for guiding a path of the well may be automatically generated by the learning machine 175 in real-time. For clarity, flow skips to block 214.

At block 214, a geosteering system having a UI receives live, real-time data from a current geosteering job. For example, the geosteering system may be configured to receive resistivity data from the resistivity sensor 117 in real time, although data from other sensors may be input into the geosteering system. The geosteering system may be configured to invert the resistivity data in real time. The real-time data obtained by the geosteering system may be output to the trained learning machine 175 for interpretation. Flow progresses to block 216.

At block 216, the trained learning machine 175 collaborates with and outputs suggestions to the geosteering system of the computer 170. For example, the geosteering system of block 214 may, in a secure manner, integrate with the trained learning machine 175. The geosteering system may feed real-time resistivity data and images of resistivity inversions into the trained learning machine 175. The trained learning machine 175 may be configured to interpret the input data and generate an image including a resistivity inversion interpretation based on the data from the geosteering system. The learning machine 175 may also output associated image data. In some implementations, the learning machine 175 may be configured to forecast predicted bed boundaries, formation properties, etc. based on the inputs received by the learning machine 175, although decisions to alter the path of the drilling assembly 116 may be based on real-time, current data.

The trained learning machine 175 may be configured to analyze the current state of a geosteering job based on the input data. The trained learning machine 175 may compare the input resistivity data and inversion, for example, to the archive of historical data within blocks 202, 204. The trained learning machine 175 may output well-composed, detailed well path suggestions similar to the suggested interpretation of block 210 based on the comparison of real-time job data to the library of historical data including the archived reports. The trained learning machine 175 may also output a resistivity inversion interpretation. Flow progresses to block 218.

At block 218, the trained learning machine 175 outputs a resistivity inversion interpretations and well path suggestions, annotations, etc. in real-time to a geosteerer. The geosteerer may view the image output by the trained learning machine 175 and associated commentary (well path suggestions, annotations of notable events, objects, etc.) through a UI of the geosteering system. In some implementations, the geosteerer may be given the decision to approve or reject the well path and/or interpretation suggestions through the UI. For example, a geosteerer on the job may be able to deny interpretations output by the trained learning machine 175 via the geosteering system of block 214. If the suggestions are denied, flow returns to block 214 where the learning machine 175 may suggest an alternate interpretation. In some implementations, the learning machine 175 may receive additional training and adjustments based on geosteerer feedback during deployment. The feedback from the geosteerer may also be added to the archive of historical data which the learning machine may refer back to for future interpretations. If the geosteerer approves of the well path suggestions and interpretation image output by the learning machine, then the learning machine 175 may be configured to automatically update the UI so the geosteerer may guide the drilling assembly 116 and drill bit 112 along the suggested path. Thus, the suggested interpretation may be added to the geosteerer's interpretation of the subsurface. This process may be repeated a plurality of times throughout a geosteering operation. In some implementations, inputs from the geosteerer may be compared against the library of historical data of which the learning machine 175 was trained with. Flow of the method 200 ceases.

### Example Computer

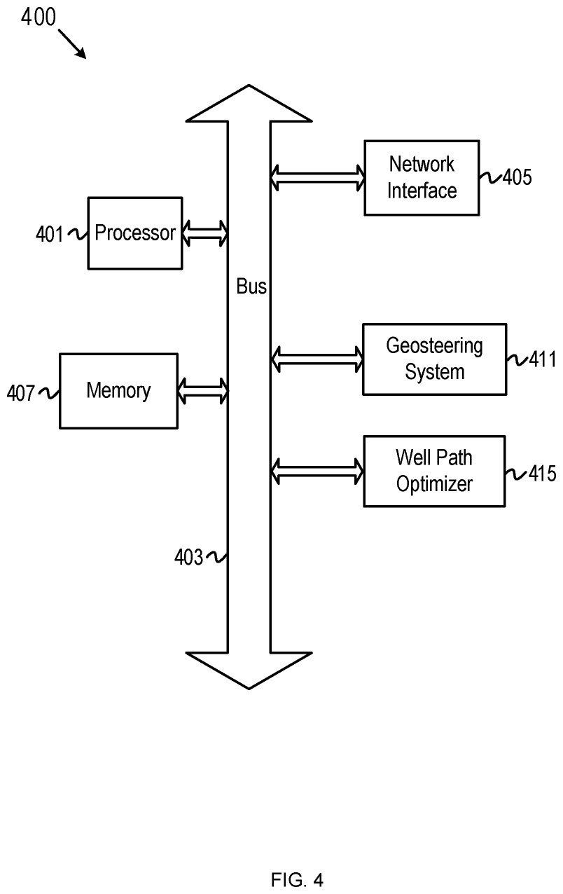

FIG. 4 is a block diagram depicting an example computer 400, according to some implementations. The computer 400 includes a processor 401 (possibly including multiple processors, multiple cores, multiple nodes, and/or implementing multi-threading, etc.). The computer 400 includes memory 407. The memory 407 may be system memory or any one or more of the above already described possible realizations of machine-readable media. The computer 400 also includes a bus 403 and a network interface 405. The computer 400 may communicate via transmissions to and/or from remote devices via the network interface 405 in accordance with a network protocol corresponding to the type of network interface, whether wired or wireless and depending upon the carrying medium. For example, the geosteering system 411 may include a user interface which may be accessed via secure login to a cloud computing service, the user interface may be output to an on-site computer, the user interface may be output to a remote device, etc. In addition, a communication or transmission may involve other layers of a communication protocol and or communication protocol suites (e.g., transmission control protocol, Internet Protocol, user datagram protocol, virtual private network protocols, etc.).

The computer 400 also includes the geosteering system 411 and a well path optimizer 415 (i.e., the learning machine 175) which may perform the operations described herein. For example, the geosteering system 411 may be configured to perform the above-described operations with reference to the geosteering system of FIG. 2 (e.g., obtaining real-time resistivity measurements, inverting the data, and communicating the data to the well path optimizer 415). The well path optimizer 415 may be configured perform all of the operations performed by the learning machine 175 including interpreting resistivity inversions, outputting an interpretation image with well path suggestions to a geosteerer in real-time, etc. The geosteering system 411 and the well path optimizer 415 may be in communication. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

### Example Operations

FIG. 5 is a flowchart 500 of an example method for optimizing a well path of a wellbore being drilled into a subsurface formation in real-time, according to some implementations. The operations of flowchart 500 are described in reference to FIGS. 1-4. Additionally, a learning machine described in the operations of the flowchart 500 is described with reference to the well path optimizer 415 of FIG. 4 and with reference to the learning machine 175 described in FIGS. 1-3. Operations of the flowchart 500 begin at block 502.

At block 502, the method includes inputting an image of a resistivity inversion into a learning machine. For example, the geosteering system 411 may obtain real-time resistivity data from the resistivity sensor 117. The geosteering system 411 may invert the resistivity data to create an image, and this image may be input into the well path optimizer 415. Flow progresses to block 504.

At block 504, the method includes comparing, via the learning machine, the input image of the resistivity inversion against an archive of historical data. For example, the well path optimizer 415 may analyze subsections of the resistivity inversion image (generated during the current job) to find similar trends/patterns and corresponding suggestions, annotations, geosteerer's notes and/or corrective actions in the archive of historical data depicted in blocks 202-204. Flow progresses to block 506.

At block 506, the method includes generating, based on the comparison, a real-time well path suggestion. For example, the well path optimizer 415 may be configured to output a resistivity inversion interpretation with suggestions, annotations, etc. The suggestions may be configured to match individual well goals. The real-time well path suggestion may be used to guide the drilling assembly 116 along an optimal well path. Flow progresses to block 508.

At block 508, the method includes outputting the real-time well path suggestion to a user interface. For example, the real-time well path suggestion may be output to a user interface viewable by the geosteerer of block 218. The geosteerer may approve or deny the suggested interpretation and/or commentary output by the well path optimizer 415. Input from the geosteerer may be used to further train the well path optimizer 415. Flow of the flowchart 500 ceases.

While the aspects of the disclosure are described with reference to various implementations and exploitations, it will be understood that these aspects are illustrative and that the scope of the claims is not limited to them. In general, techniques for well path optimization via a learning machine as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### EXAMPLE IMPLEMENTATIONS

Implementation #1: A system configured for real-time well path optimization of a wellbore being drilled into a subsurface formation, the system comprising: a downhole tool including a resistivity sensor; a drilling assembly coupled to a drill bit, the drilling assembly including the downhole tool; and a learning machine configured to, compare an input image of a resistivity inversion against an archive of historical data; generate, based on the comparison, a real-time well path suggestion; and output the real-time well path suggestion to a user interface.

Implementation #2: The system of the Implementation 1, wherein the learning machine is further configured to: output a resistivity inversion interpretation of the input image to the user interface; and output one or more annotations of the resistivity inversion interpretation to the user interface.

Implementation #3: The system of any one or more of the Implementations 1-2, wherein the real-time well path suggestion includes text readable by a user.

Implementation #4: The system of any one or more of the Implementations 1-3, wherein the learning machine is trained using the archive of historical data.

Implementation #5: The system of any one or more of the Implementations 1-4, wherein the learning machine is further configured to: output, via the user interface, a decision to a user as whether to implement the real-time well path suggestion.

Implementation #6: The system of any one or more of the Implementations 1-5, wherein the learning machine is further configured to: update the archive of historical data based on a result of the decision.

Implementation #7: The system of any one or more of the Implementations 1-6, further configured to: alter a well path of the wellbore based, at least in part, on the real-time well path suggestion.

Implementation #8: One or more non-transitory machine-readable media including instructions executable by a processor to cause the processor to configured to optimize a path of a wellbore being drilled into a subsurface formation in real-time, the instructions comprising: instructions to input an image of a resistivity inversion into a learning machine; instructions to compare, via the learning machine, the input image of the resistivity inversion against an archive of historical data; instructions to generate, based on the comparison, a real-time well path suggestion; and instructions to output the real-time well path suggestion to a user interface.

Implementation #9: The machine-readable media of the Implementation 8, further comprising: instructions output a resistivity inversion interpretation of the input image to the user interface; and instructions to output one or more annotations of the resistivity inversion interpretation to the user interface.

Implementation #10: The machine-readable media of any one or more of the Implementations 8-9, wherein the real-time well path suggestion includes text readable by a user.

Implementation #11: The machine-readable media of any one or more of the Implementations 8-10, wherein the learning machine is trained using the archive of historical data.

Implementation #12: The machine-readable media of any one or more of the Implementations 8-11, further comprising: instructions to output, via the user interface, a decision to a user as whether to implement the real-time well path suggestion.

Implementation #13: The machine-readable media of any one or more of the Implementations 8-12, further comprising: instructions to update the archive of historical data based on a result of the decision.

Implementation #14: A method for optimizing a well path of a wellbore being drilled into a subsurface formation in real-time, the method comprising: inputting an image of a resistivity inversion into a learning machine; comparing, via the learning machine, the input image of the resistivity inversion against an archive of historical data; generating, based on the comparison, a real-time well path suggestion; and outputting the real-time well path suggestion to a user interface.

Implementation #15: The method of the Implementation 14, further comprising: outputting a resistivity inversion interpretation of the input image to the user interface; and outputting one or more annotations of the resistivity inversion interpretation to the user interface.

Implementation #16: The method of any one or more of the Implementations 14-15, further comprising: training the learning machine using the archive of historical data.

Implementation #17: The method of any one or more of the Implementations 14-16, wherein outputting the real-time well path suggestion comprises outputting a textual real-time well path suggestion readable by a user to the user interface.

Implementation #18: The method of any one or more of the Implementations 14-17, further comprising: outputting, via the user interface, a decision to a user as whether to implement the real-time well path suggestion.

Implementation #19: The method of any one or more of the Implementations 14-18, further comprising: updating the archive of historical data based on a result of the decision.

Implementation #20: The method of any one or more of the Implementations 14-19, further comprising: altering the well path of the wellbore based, at least in part, on the real-time well path suggestion.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A system configured for real-time well path optimization of a wellbore being drilled into a subsurface formation, the system comprising:
a downhole tool including a resistivity sensor;
a drilling assembly coupled to a drill bit, the drilling assembly including the downhole tool; and
a learning machine configured to,
compare an input image of a resistivity inversion against an archive of historical data;
generate, based on the comparison, a real-time well path suggestion; and
output the real-time well path suggestion to a user interface.

2. The system of claim 1, wherein the learning machine is further configured to:
output a resistivity inversion interpretation of the input image to the user interface; and
output one or more annotations of the resistivity inversion interpretation to the user interface.

3. The system of claim 1, wherein the real-time well path suggestion includes text readable by a user.

4. The system of claim 1, wherein the learning machine is trained using the archive of historical data.

5. The system of claim 1, wherein the learning machine is further configured to:
output, via the user interface, a decision to a user as whether to implement the real-time well path suggestion.

6. The system of claim 5, wherein the learning machine is further configured to:
update the archive of historical data based on a result of the decision.

7. The system of claim 1, further configured to:
alter a well path of the wellbore based, at least in part, on the real-time well path suggestion.

8. One or more non-transitory machine-readable media including instructions executable by a processor to cause the processor to configured to optimize a path of a wellbore being drilled into a subsurface formation in real-time, the instructions comprising:
instructions to input an image of a resistivity inversion into a learning machine;
instructions to compare, via the learning machine, the input image of the resistivity inversion against an archive of historical data;
instructions to generate, based on the comparison, a real-time well path suggestion; and
instructions to output the real-time well path suggestion to a user interface.

9. The machine-readable media of claim 8, further comprising:
instructions output a resistivity inversion interpretation of the input image to the user interface; and
instructions to output one or more annotations of the resistivity inversion interpretation to the user interface.

10. The machine-readable media of claim 8, wherein the real-time well path suggestion includes text readable by a user.

11. The machine-readable media of claim 8, wherein the learning machine is trained using the archive of historical data.

12. The machine-readable media of claim 8, further comprising:
instructions to output, via the user interface, a decision to a user as whether to implement the real-time well path suggestion.

13. The machine-readable media of claim 12, further comprising:
instructions to update the archive of historical data based on a result of the decision.

14. A method for optimizing a well path of a wellbore being drilled into a subsurface formation in real-time, the method comprising:
inputting an image of a resistivity inversion into a learning machine;
comparing, via the learning machine, the input image of the resistivity inversion against an archive of historical data;
generating, based on the comparison, a real-time well path suggestion; and
outputting the real-time well path suggestion to a user interface.

15. The method of claim 14, further comprising:
outputting a resistivity inversion interpretation of the input image to the user interface; and
outputting one or more annotations of the resistivity inversion interpretation to the user interface.

16. The method of claim 14, further comprising:
training the learning machine using the archive of historical data.

17. The method of claim 14, wherein outputting the real-time well path suggestion comprises outputting a textual real-time well path suggestion readable by a user to the user interface.

18. The method of claim 14, further comprising:
outputting, via the user interface, a decision to a user as whether to implement the real-time well path suggestion.

19. The method of claim 18, further comprising:
updating the archive of historical data based on a result of the decision.

20. The method of claim 14, further comprising:
altering the well path of the wellbore based, at least in part, on the real-time well path suggestion.
